(19) United States
(12) Patent Application Publication
(10) Pub. No.: US 2006/0237524 A1
(43) Pub. Date: Oct. 26, 2006

(54) CLOSING DOCUMENT STORAGE

(76) Inventor: Tom Wentworth, Bloomington, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/379,005

(22) Filed: Apr. 17, 2006

Related U.S. Application Data
(60) Provisional application No. 60/672,112, filed on Apr. 15, 2005.

(51) Int. Cl. G06F 17/00

(52) U.S. Cl. 235/375

(57) ABSTRACT

Systems and method to store closing documents. Some embodiments include receiving data of one or more parties to a transaction acquire a transaction document set including one or more documents and identifying each document in the document set to associate a document description and one or more parties to receive a copy of each identified document. Some such embodiments further include receiving service provider data of each of one or more service providers providing service to each of the one or more parties and generating a computer readable medium for each party to the transaction. The computer readable medium can include a portion of the document set, a document description link index linking each document description to the description's respective document written to the computer readable medium, and service provider data of at least one service provider.

### RELATED APPLICATION

This application claims the benefit of U.S. Provisional Application Ser. No. 60/672,112 filed Apr. 15, 2005, which is incorporated herein by reference.

### TECHNICAL FIELD

The inventive subject matter relates to document management and, more particularly, to closing document storage.

### BACKGROUND INFORMATION

Sales transactions, such as real estate, automotive, and corporate transactions commonly involve large numbers of documents. These documents can originate from many sources. At a closing of a real estate transaction, for example, paper copies of these documents are provided to the various participants. In some situations, the documents provided to one party are not the same as the documents provided to another party.

A solution to this problem is to generate electronic copies of these documents and place them on a computer readable medium, such as a compact disc. However, the process of getting the documents on to the computer readable medium is a multi-step process, the success of which relies on the computer expertise of the person performing the scanning and writing of the computer readable medium. Further, if a copy of one or more of the closing documents is to be provided to only one of multiple parties, such as a copy of a promissory note, the person writing the computer readable medium must ensure such documents are copied only to the appropriate computer readable mediums.

### BRIEF DESCRIPTION OF THE DRAWINGS

FIG. 1 is a block diagram of a system according to an embodiment.

FIG. 2 is a schematic block diagram of a system according to an embodiment.

FIG. 3 is a block diagram of a method according to an embodiment.

FIG. 4A is a user interface according to an embodiment.

FIG. 4B is a user interface according to an embodiment.

FIG. 4C is a user interface according to an embodiment.

FIG. 4D is a user interface according to an embodiment.

FIG. 5 is a user interface according to an embodiment.

FIG. 6 is a user interface according to an embodiment.

FIG. 7A is a jewel case insert according to an embodiment.

FIG. 7B is a labeled compact disc according to an embodiment.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software, or a combination of software and hardware in one embodiment. The software comprises computer executable instructions stored on computer readable medium such as memory, a compact disc, or other type of storage devices. The term “computer readable medium” is also used to represent carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, Application-Specific Integrated Circuit (“ASIC”), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an ASIC. Thus, the exemplary process flows herein are applicable to software, firmware, and hardware implementations.

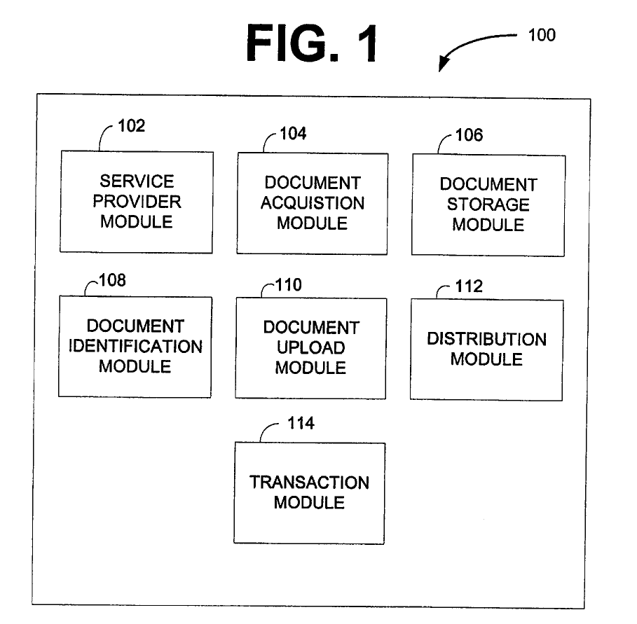

FIG. 1 is a block diagram of a system 100 according to an embodiment. The system 100 can be used to facilitate acquisition of electronic transaction documents and storing the documents on a computer readable medium in a quickly identifiable and accessible manner. In some embodiments, the computer readable medium further includes service provider information of service providers involved in the transaction. The service provider information can include one or more of a service provider name, address, phone number(s), fax number(s), picture, graphic, web site address, and email address. The service provider information can also include further information such as text, promotional material, and invoicing from the service provider to a party involved in the transaction.

In some embodiments, the system 100 includes a transaction module 114 to receive and store data representative of a transaction, such as a residential real estate transaction, a document acquisition module 104 to acquire documents associated with the transaction, and a document identification 108 module to identify acquired documents. Some embodiments of the system 100 can also includes one or more of a document storage module 106 to store identified documents, a distribution module 112 to generate a distributable electronic record of the transaction including copies of documents associated with the transaction, and a service provider module 102 to store data representative of one or more service providers.

In the system 100, the data representative of a transaction in the transaction module 114 can include an association to one or more of the service providers in the service provider module 102. Further, the distributable electronic record of the transaction generated by the distribution module 112 can include service provider data of each service provider associated with the transaction in the service provider module 102. In an embodiment, the service provider data includes data relating to service providers or merchants that are not involved in the transaction but do provide services related to a residence or other services or items directed toward a party to the transaction. Such non-involved service providers and merchants include electricians, carpenters, plumbers, roofers, refinance companies, masons, law firms, landscapers, trash removal services, home improvement and hardware stores, and other merchants. As these non-involved service providers and merchants are not involved in the transaction, they may pay a fee to the preparer to be included with the distributable electronic record of the transaction. The electronic record of the transaction can be written by distribution module 112 to one or more computer readable mediums, such as a compact disc or a digital versatile disc (DVD).

In some further embodiments, the system 100 includes a document upload module 110 to upload transaction data including documents over a network to an archiving server. The network can include the a local area network (LAN), a wide area network (WAN), a storage or system area network (SAN), or a global interconnection network, such as the Internet. The network archiving server can include a network storage location, such as a database. The networking archiving server can also include an online real estate transaction closing document archiving server provided by a application service provider or other company, such as the SureClose® service operated Stewart Realty Solutions of Houston, Tex. (See http://www.sureclose.com). The networking archiving server also can include servers of governmental property recording offices that maintain real estate records.

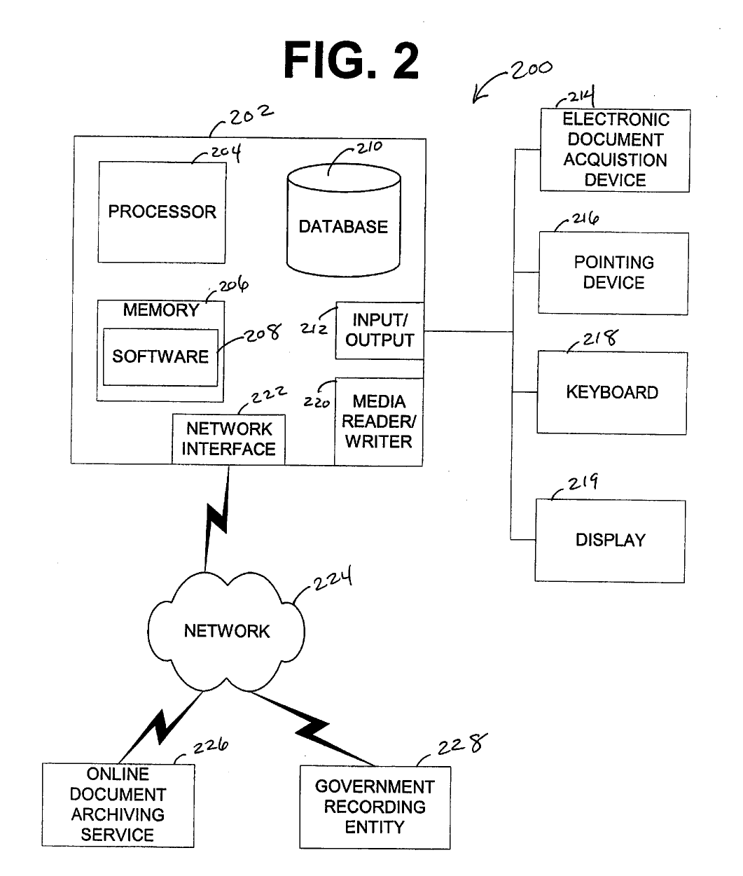

FIG. 2 is a schematic block diagram of a system 200 according to an embodiment. The system 200 illustrated in FIG. 2 is a more detailed perspective of an embodiment of the inventive subject matter. The system 200 includes a computer 202 having a processor 204, a memory 206, a database 210, one or more input/output ports 212, a media reader/writer 220, and a network interface 222. The computer 202 can be a personal computer, a server, a networked appliance, or virtually any type of computing device capable of processing instructions.

The processor 204 of the computer 202 represents a digital signal processor or processing unit of any type of architecture, such as an ASIC (Application-Specific Integrated Circuit), a CISC (Complex Instruction Set Computing), RISC (Reduced Instruction Set Computing), VLIW (Very Long Instruction Word), or hybrid architecture, although any appropriate processor may be used. One common type of processor is an Intel® processor such as a Pentium® or Celeron®. The processor 204 executes instructions. In some embodiments, the processor 204 also includes a control unit that organizes data and program storage in memory 206 and transfers data and other information in and out of the computer 202.

The memory 206 represents one or more mechanisms for storing data. For example, the memory 206, in various embodiments, includes one or more of a read only memory (ROM), random access memory (RAM), magnetic disk storage media, optical storage media, flash memory devices, and/or other volatile and non-volatile machine-readable media. In other embodiments, any appropriate type of storage device or memory 206 can be used. Although only one memory 206 is shown, multiple memories 206 and multiple types of storage devices can be present.

The database 210 represents a storage location within the computer 202. The database 210 can include a storage device, such as a hard drive. The database 210 can also include a database application, such as a relational database program that provides the ability to read, write, and update data, including documents, in a relational manner.

The input/output port 212 represents one or more ports of the computer 202 to connect to other devices. The other devices can include a pointing device 216 and a keyboard 218 from which computer 202 stimulation commands can be received from a user. The other devices can also include an electronic document acquisition device 214. In some embodiments, the electronic document acquisition device 214 can include an imager, a scanner, a multi-function device such as a photocopier including document scanning capabilities, a camera, a facsimile device capable of generating electronic images from received or outgoing facsimile transmissions, or virtually any other device capable of generating an electronic copy of a document, such as a fixed, non-editable text document or a fixed image of a document. The document acquisition device 214, in some embodiments, acquires an image of the pages of a document and generates an electronic copy of the document in an electronic format. The electronic format can include the Portable Document Format (PDF) that can be read and manipulated using software available from Adobe System Incorporated of San Jose, Calif. Other electronic document formats are used in other embodiments. Some such formats include the formats JPEG, TIFF, or virtually any other format capable of holding an electronic copy of an acquired document.

The media reader/writer 220 can include a device capable of reading and writing to a computer readable medium. In various embodiments, the computer readable medium can include a compact disc (CD), a digital versatile disc (DVD), a floppy disk, a removable or portable hard drive, a universal serial bus (USB) non-volatile memory device, or virtually any other type of computer readable medium capable of storing data.

The network interface 222 of the computer represents one or more wired or wireless network interfaces to facilitate data communications between the computer 202 and other clients and servers on a network 224. The other clients and servers on the network 224 can include an online document archive service 226 and a government recording entity 228.

The memory 206, in some embodiments, can include software 208. The software 208 can cause the computer 202 to provide a user interface to request and receive transaction data from a user. The transaction data can include data identifying one or more parties to a transaction, data identifying service providers involved in the transaction and associated with one or more of the parties, an electronic copy and description of one or more transaction documents, an association of each transaction document to one or more of the parties, service providers, or both, and data representative of the transaction subject matter. The one or more parties to the transaction can include one or more buyers and one or more sellers. The subject matter of the transaction is real estate. In other embodiments, the subject matter can include one or more automotives, art work, a business enterprise, or other property or service that can be bought and sold in a transaction involving documents.

In some embodiments, the software 208 can further cause the computer 202 to generate a computer readable medium for each party to the transaction. In some embodiments, the computer readable medium is a compact disc for one party, such as a buyer, and includes copies of the transaction documents associated with the buyer, service provider data of each service provider associated to the buyer, and a document access user interface including a link to each of the transaction documents and a link to the service provider data of each service provider associated to the buyer. In some embodiments, the software 208 can further cause the computer 202 to generate a computer readable medium for the seller in the same transaction. The computer readable medium for the seller can include the same, different, or a subset of documents provided to the buyer on the buyer's compact disc. This prevents the seller from receiving copies of the buyer's sensitive documents, such as credit reports or other personal information. The software decides which documents to write to which computer readable medium as a function of either the document type and/or the association of each document to one or more of the parties. Examples of transaction documents a seller receives include a seller's disclosure form, appraisal, purchase agreement, truth-in-lending reports, documents including seller-sensitive information, and lead paint, well, fuel tank, and asbestos disclosures. Examples documents a buyer receives further include credit reports, credit applications, an inspection report, and other documents including buyer-sensitive information.

In some embodiments, documents written on a computer readable medium are encrypted and require a password to decrypt. In one such embodiment, each party to a transaction is provided with a unique password. This allows each party to decrypt only documents intended for that party. This allows all transaction documents to be intentionally or even unintentionally provided to all parties, but each party is only able to decrypt their own documents. In yet a further embodiment, the computer readable medium includes decrypting software that must be used to decrypt documents stored on the computer readable medium. This prevents the transaction documents from being viewed separately from the computer readable medium. In some embodiments, only sensitive documents, such as a credit report or mortgage application, are encrypted.

In some embodiments, the document access user interface of a generated computer readable medium is encoded in a markup language. The markup language is virtually any markup language capable of display in a web browser, such as Internet Explorer available from Microsoft Corporation of Redmond, Wash. The document access user interface includes a hyperlink to each transaction document written to the computer readable medium and a hyperlink to the service provider data of each service provider associated to the party. In various embodiments, the hyperlink to the service provider data includes one or more of an email address hyperlink, a hyperlink to service provider data on the computer readable medium, and a hyperlink to a network location, such as an Internet web site. The service provider can include one or more of a picture, a name, an email address, a web site address, and an address.

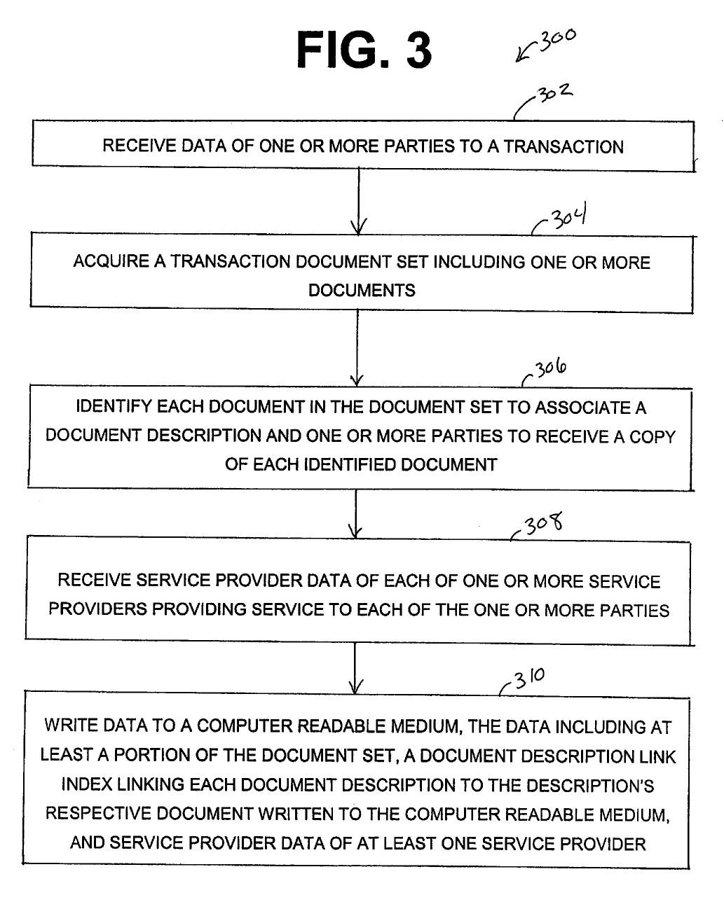

FIG. 3 is a block diagram of a method 300 according to an embodiment.

The method 300 includes receiving data of one or more parties to a transaction 302, acquiring a transaction document set including one or more documents 304, and identifying each document in the document set to associate a document description and one or more parties to receive a copy of each identified document 306. The method 300 further includes receiving service provider data of each of one or more service providers providing service to each of the one or more parties 308 and writing data to a computer readable medium. The data includes at least a portion of the document set, a document description link index linking each document description to the description's respective document written to the computer readable medium, and service provider data of at least one service provider 310.

In some embodiments, the document description index is created automatically based on document descriptions of documents in the document set. The automatically created index can then be displayed and a confirmation received indicating that the index is correct and all documents intended to be on the computer readable medium are identified and ready to be written.

The service providers can include a closing company and representative, one or more sales agents, a mortgage officer, a title company, an attorney, an appraiser, a property inspector, a home repair service company, or virtually any other service provider that performs services related to a transaction. In some embodiments, a service provider can also include a person or company wanting to sell services to a party to the transaction. For example, a trash company may want business from the buyer. The trash company provides its information, which can include a printable coupon, and that information is written to the computer readable medium provided to the buyer.

In some embodiments, the method 300 also includes identifying the subject matter of the transaction. Identifying the subject matter of the transaction can include receiving an address of a property and an electronic image of at least a portion of the property.

In some embodiments, acquiring a transaction document set 304 includes receiving an electronic copy of one or more documents in the native format of the document, such as a word processing documents, wherein one of the documents includes a digital signature of one of the parties to the transaction.

In some embodiments, writing data to a computer readable medium 310 includes writing a computer readable medium for each party to the transaction, wherein a party's computer readable medium only includes identified documents the party is to receive.

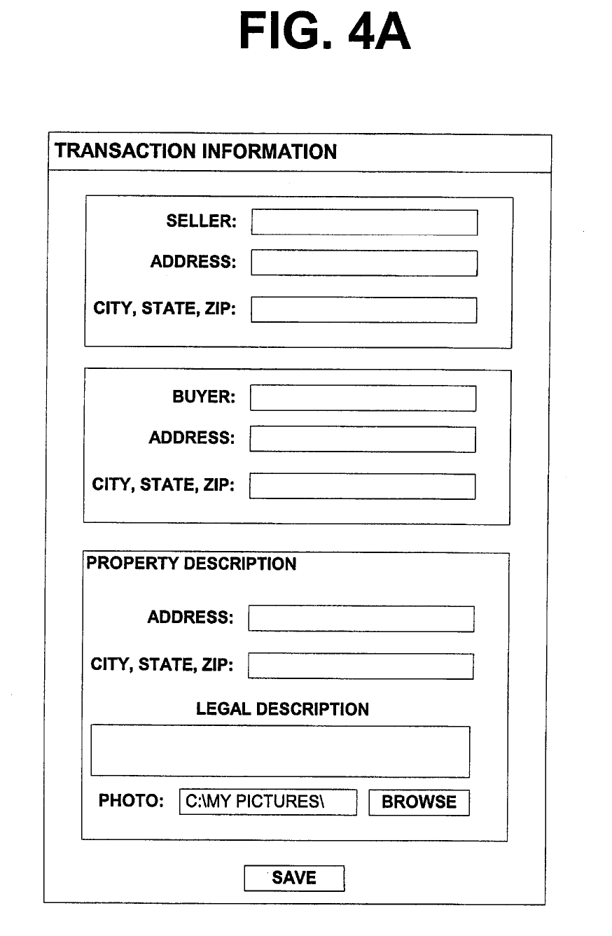

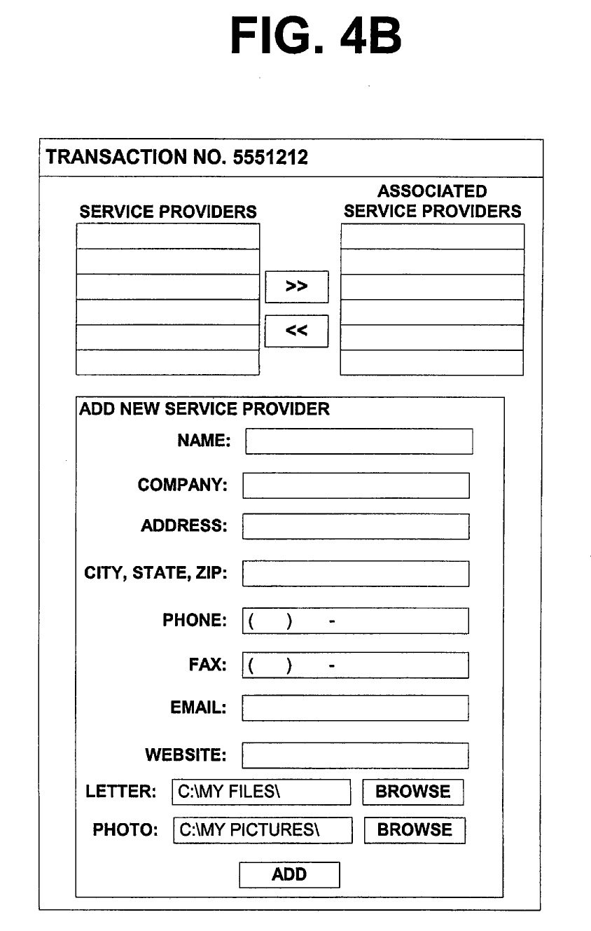

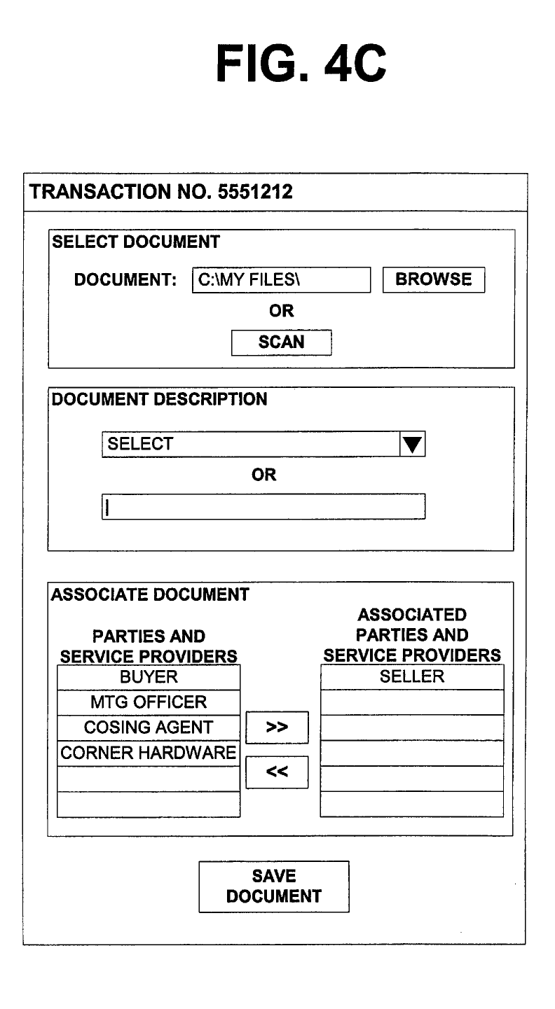

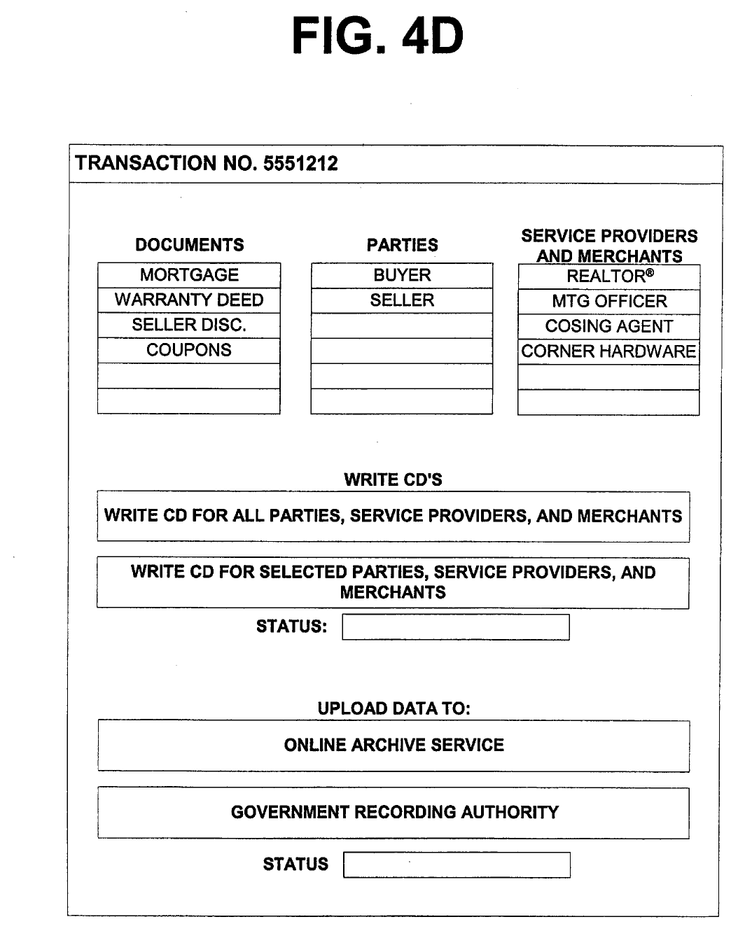

FIG. 4A, FIG. 4B, FIG. 4C, and FIG. 4D each provide a user interface according to an embodiment. The user interfaces of FIG. 4A is useful to receive transaction information. The user interface of FIG. 4B is useful to add service providers and associate service providers to a transaction. The user interface of FIG. 4C is useful to add documents to a transaction record and associate each document to one or more parties and/or service providers. The user interface of FIG. 4D is useful to write a compact disc for one or more parties and/or service providers and upload transaction data and documents to an online archive server or government recording authority.

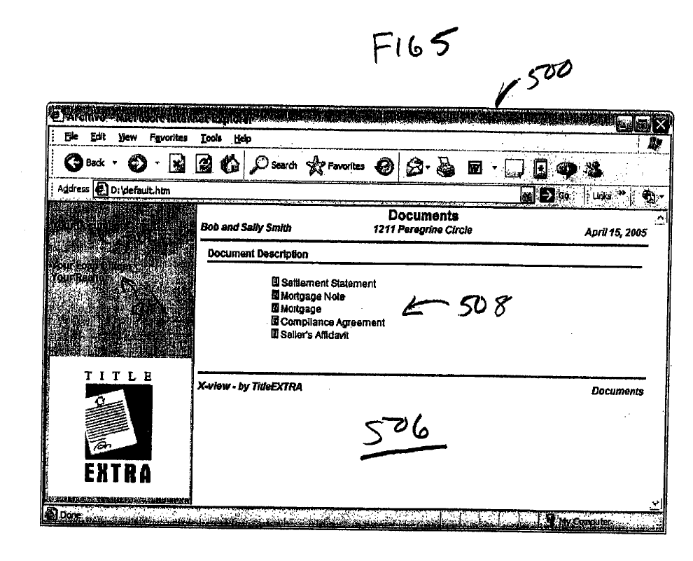

FIG. 5 is a user interface 500 according to an embodiment. The user interface 500 is an example user interface of a computer readable medium having transaction documents written to it according to the systems and methods described herein.

The user interface 500 includes a contents portion 501 and an index portion 506. The contents portion provides a hyperlink to “Your Documents” 502 and hyperlinks to service provider information 504. The hyperlink to “Your Documents” 502 is a link to cause the index portion 506 to display within the user interface 500. The index portion 506 includes a number of hyperlinks 508 to documents stored on the computer readable medium, the selection of which causes the selected document to be displayed.

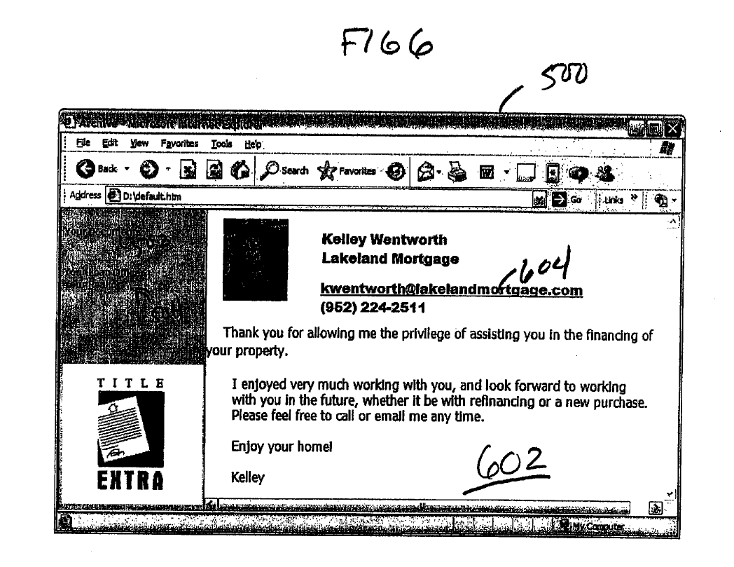

The hyperlinks to service provider information can include one or more links to service provider information stored on the computer readable medium, an Internet website, or to an email address. FIG. 6 illustrates the user interface 500 after the selection of a service provider hyperlink 504. The selection of the service provider hyperlink causes the service provider information 602 to display in place of the index portion 506. The service provider information 602 can include a hyperlink 604 to obtain more information from the service provider, such as an email hyperlink.

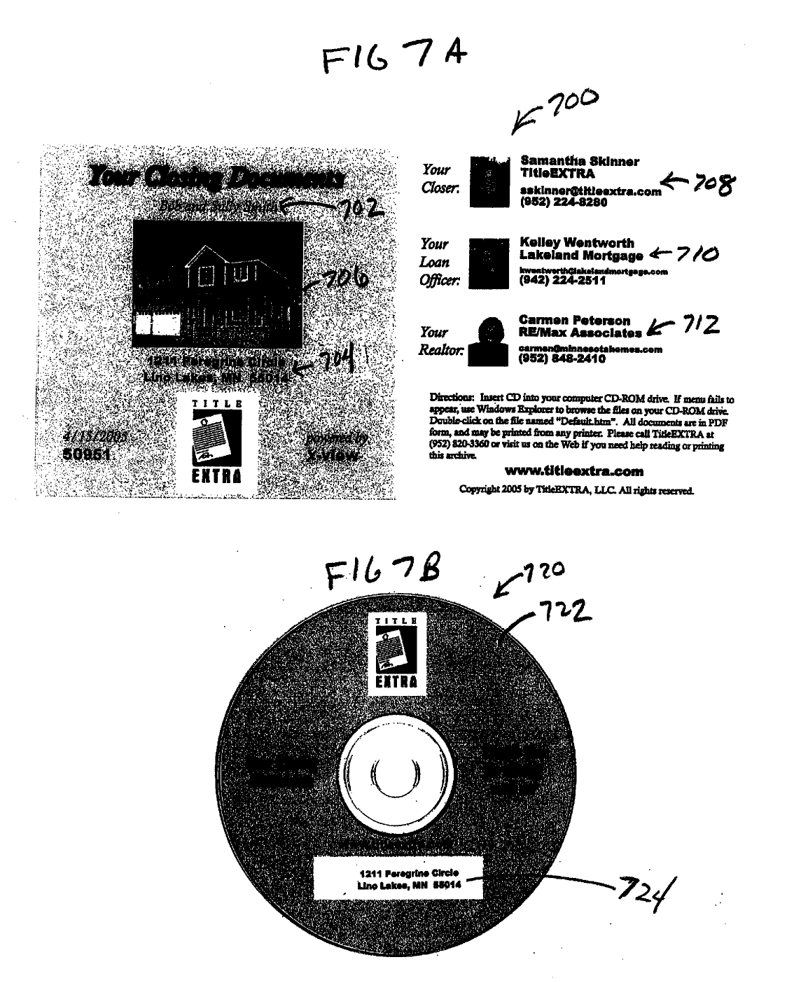

FIG. 7A is a jewel case insert 700 according to an embodiment. The jewel case insert can be generated based on the transaction data that is acquired in the systems and methods described herein. The jewel case insert includes a party name 702, a picture of at least a portion of a property that is the subject matter of the transaction, a property address, and service provider information 708, 710, and 712 of service providers involved in the transaction.

FIG. 7B is a labeled compact disc 720 according to an embodiment. The compact disc 720 is written to according to the systems and methods described herein. The compact disc 720 includes a label 722 having the address of the property that is the subject matter of the transaction printed on it directly or on a sticker attached thereto.

In the foregoing Detailed Description, various features are grouped together in a single embodiment to streamline the disclosure. This method of disclosure is not to be interpreted as reflecting an intention that the claimed embodiments of the inventive subject matter require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter may be made without departing from the principles and scope of the inventive subject matter as expressed in the subjoined claims.

What is claimed is:

1. A method comprising:
receiving data of one or more parties to a transaction;
acquiring a transaction document set including one or more documents;
identifying each document in the document set to associate a document description and one or more parties to receive a copy of each identified document;
receiving service provider data of each of one or more service providers providing service to each of the one or more parties; and
writing data to a computer readable medium, the data including at least a portion of the document set, a document description link index linking each document description to the description's respective document written to the computer readable medium, and service provider data of at least one service provider.

2. The method of claim 1, further comprising identifying the subject matter of the transaction.

3. The method of claim 2, wherein identifying the subject matter of the transaction includes receiving an address of a property and an electronic image of at least a portion of the property.

4. The method of claim 1, wherein acquiring a transaction document set includes receiving an image of each document in the document set from a document imaging device.

5. The method of claim 1, wherein the document imaging device is a scanner.

6. The method of claim 1, wherein acquiring a transaction document set includes receiving an electronic copy of one or more documents in the document set, wherein one of the documents includes a digital signature of one of the parties to the transaction.

7. The method of claim 1, wherein identifying each document in the document set includes receiving a selection of a document description from a list of descriptions provided in a user interface control of a system performing the method, further wherein identifying one or more parties to receive a copy of each identified document includes receiving a selection of a party from a list of the one or more parties to the transaction in a user interface control of the system performing the method.

8. The method of claim 1, wherein identifying each document in the document set includes receiving a document description in a user interface control provided to a user of a system performing the method, further wherein identifying one or more parties to receive a copy of each identified document includes receiving a document description in a user interface control of the system performing the method.

9. The method of claim 1, wherein obtaining service provider data of each of one or more service providers includes receiving the service provider data of each service provider into one or more user interface controls of a system performing the method.

10. The method of claim 9, wherein the service provider data includes a picture of a service provider representative and contact information of the service provider representative.

11. The method of claim 1, wherein writing data to a computer readable medium includes writing a computer readable medium for each party to the transaction, wherein a party's computer readable medium only includes identified documents the party is to receive.

12. A computer system comprising:
a transaction module to receive and store data representative of a transaction;
a document acquisition module to acquire documents associated with the transaction;
a document identification module to identify acquired documents;
a document storage module to store identified documents; and
a distribution module to generate a distributable electronic record of the transaction including copies of documents associated with the transaction.

13. The computer system of claim 12, further comprising:
a service provider module to store data representative of one or more service providers;
wherein the data representative of a transaction includes an association to one or more of the service providers; and
further wherein the distributable electronic record of the transaction includes service provider data of each service provider associated with the transaction.

14. The computer system of claim 12, wherein the electronic record of the transaction is written by the distribution module to one or more compact discs.

15. The computer system of claim 12, further comprising:
a document upload module to upload transaction data including documents over a network to an archiving server.

16. The computer system of claim 15, wherein the archiving server can include a server of a governmental property record recording office and a server of a service that provides online access to real estate closing documents.

17. The computer system of claim 15, wherein the network is the Internet.

18. A system comprising:
software in a memory and operable on a processor to:
provide a user interface to request and receive transaction data including:
data identifying one or more parties to a transaction, data identifying service providers involved in the transaction, wherein
each service provider is associated with one or more of the parties,
an electronic copy and description of one or more transaction documents,
an association of each transaction document to one or more of the parties, one or more service providers, or both, and
data representative of the transaction subject matter;
generate a computer readable medium for each party to the transaction, the computer readable medium for a party to include:
the transaction documents associated with the party,
service provider data of each service provider associated to the party, and
a document access user interface including a link to each of the transaction documents and a link to the service provider data of each service provider associated to the party.

19. The system of claim 18, wherein the document access user interface is encoded in a markup language and includes a hyperlink to each transaction document and a hyperlink to the service provider data of each service provider associated to the party.

20. The system of claim 18, wherein the transaction subject matter is real estate.

21. The system of claim 18, wherein the data identifying each service provider includes one or more of a picture, a name, an email address, a web site address, and an address.
